(19) United States
(12) Patent Application Publication
(10) Pub. No.: US 2020/0290873 A1
(43) Pub. Date: Sep. 17, 2020

(54) AQUEOUS HYDROGEN PEROXIDE PURIFICATION METHOD AND PURIFICATION SYSTEM

(71) Applicant: KURITA WATER INDUSTRIES LTD., tokyo (JP)

(72) Inventors: Ikunori YOKOI, Tokyo (JP); Yoshiaki IDE, Tokyo (JP)

(21) Appl. No.: 16/341,610

(22) PCT Filed: Sep. 19, 2017
(86) PCT No.: PCT/JP2017/033646

§ 371 Date: Apr. 12, 2019

(30) Foreign Application Priority Data
Oct. 20, 2016 (JP) 2016-206085

(51) Int. Cl. C01B 15/013; B01D 61/02; B01D 69/02; C02F 1/44; C02F 1/42; B01J 39/05; B01J 39/20; B01J 41/05; B01J 41/14; B01J 47/028; C08F 212/08

(52) U.S. Cl. CPC C01B 15/0135; C02F 2101/30; B01D 69/02; C02F 1/441; C02F 1/42; B01J 39/05; B01J 39/20; B01J 41/05; B01J 41/14; B01J 47/028; C08F 212/08; B01D 2311/2623; B01D 2325/20; C02F 2001/422; C02F 2001/425; B01D 61/025

(57) ABSTRACT

A purification method for an aqueous hydrogen peroxide solution includes subjecting the aqueous hydrogen peroxide solution to a reverse osmosis membrane separation treatment with a high-pressure reverse osmosis membrane separation device. The high-pressure reverse osmosis membrane has a denser skin layer on the membrane surface and is therefore lower in an amount of membrane permeate water per unit operating pressure but higher in the rejection rate of TOC and boron, as compared with a low-pressure or ultralow-pressure reverse osmosis membrane. The high-pressure reverse osmosis membrane permeate water is preferably further subjected to an ion exchange treatment with an ion exchange device including two or more columns packed with gel-type strong ion exchange resins.

### TECHNICAL FIELD

The present invention relates to a purification method and a purification system for an aqueous hydrogen peroxide solution. The present invention particularly relates to a purification method and a purification system for efficiently removing the total organic carbon (TOC) and boron, which are difficult to remove by an ion exchange treatment, in an aqueous hydrogen peroxide solution.

### BACKGROUND ART

An aqueous hydrogen peroxide solution is generally produced by the autoxidation of an anthracene derivative (anthraquinone autoxidation method) as follows:

2-Ethyl-anthrahydroquinone or 2-amyl-anthrahydroquinone is dissolved in a solvent and is allowed to mix with oxygen in the air to oxidize the anthrahydroquinone, thereby producing anthraquinone and hydrogen peroxide. The produced hydrogen peroxide is extracted with ion-exchanged water to separate the hydrogen peroxide from the anthraquinone. The resulting extract is distilled under reduced pressure to obtain an aqueous hydrogen peroxide solution having a concentration of 30 to 60% by weight. The anthraquinone as a by-product is converted back into the anthrahydroquinone by hydrogen reduction with a nickel or palladium catalyst, and reused.

The 30 to 60% by weight aqueous hydrogen peroxide solution obtained by distillation under reduced pressure is not necessarily high in purity of hydrogen peroxide, and the hydrogen peroxide would be decomposed by metal impurities contained in the solution.

In Patent Literature 1, a stabilizer (a hydrogen peroxide decomposition inhibitor) is added to an aqueous hydrogen peroxide solution to inhibit the decomposition of hydrogen peroxide.

Examples of the stabilizer to be used include an inorganic chelating agent such as a phosphate, a pyrophosphate or a stannate; and an organic chelating agent such as ethylenediamine tetramethylene phosphonic acid, ethylenediamine tetraacetic acid or nitrilotriacetic acid. The stabilizer is added to the 30 to 60% by weight of aqueous hydrogen peroxide solution obtained by distillation under reduced pressure in the amount of the order of mg/L.

A high-pure aqueous hydrogen peroxide solution used as a cleaning fluid or the like in the process of manufacturing electronic components has been obtained by purifying a 30 to 60% by weight aqueous hydrogen peroxide solution having a stabilizer added thereto in this way.

The aqueous hydrogen peroxide solution used as a cleaning fluid in the process of manufacturing electronic components is required to have such qualities as a metal concentration of less than 10 ng/L and a TOC concentration of less than 10 mg/L. In order to achieve the required water quality, the 30 to 60% by weight aqueous hydrogen peroxide solution having a stabilizer added thereto has been purified by using a combination of an adsorption resin, an ion exchange resin and a chelating resin with a reverse osmosis membrane, an ultrafiltration membrane, a microfiltration membrane or the like (See, for example, Patent Literatures 1 and 2).

When a reverse osmosis membrane is used for purification of the aqueous hydrogen peroxide solution, the concentrations of salts of the resulting aqueous hydrogen peroxide solution is required to be low. Therefore, the reverse osmosis membrane used has been a low-pressure reverse osmosis membrane with a standard operating pressure of 1.47 MPa or an ultralow-pressure reverse osmosis membrane with a standard operating pressure of 0.75 MPa, as in the production of ultrapure water or the like. For example, Patent Literature 1 states that the operating pressure of the reverse osmosis membrane used is 0.49 to 1.5 MPa. Patent Literature 2 states that the operating pressure of the reverse osmosis membrane is preferably 1.5 MPa or less and preferably in the range of 0.5 to 1.0 MPa.

Regarding impurities in cleaning fluids used for cleaning in processes for manufacturing wafers and semiconductors, the concentrations of organic substances have been required to further to be reduced.

The concentrations of organic substances in ultrapure water used for cleaning have been controlled at the total organic carbon (TOC) of 1 μg/L or less, whereas TOC in a 30 to 35% by weight aqueous hydrogen peroxide solution used in a cleansing fluid has been controlled at the order of mg/L which is 1000 times or more higher than that of ultrapure water. Therefore, TOC in the aqueous hydrogen peroxide solution has caused an increase in the TOC concentration in the cleaning fluid.

For example, in the case of an SC1 (Standard Clean 1) cleaning fluid, which is a mixture of aqueous ammonia, a 30 to 35% by weight aqueous hydrogen peroxide solution and ultrapure water, mainly used for removing fine particles, the 30 to 35% by weight aqueous hydrogen peroxide solution is diluted to only about 1/3 to 1/10 by volume by ultrapure water. Therefore, the TOC concentration in the SC1 cleaning fluid immediately before cleaning is determined by the amount of a carry-over of components other than ultrapure water in the cleaning fluid such as the aqueous hydrogen peroxide solution.

In the case of an SC2 (Standard Clean 2) cleaning fluid, which is a mixture of hydrochloric acid, a 30 to 35% by weight aqueous hydrogen peroxide solution and ultrapure water, mainly used for removing metals, the 30 to 35% by weight aqueous hydrogen peroxide solution is also diluted to only about 1/5 to 1/10 by volume by ultrapure water. Therefore, the TOC concentration in the SC2 cleaning fluid immediately before used for cleaning is also determined by the amount of a carry-over of components other than ultrapure water in the cleaning fluid such as the aqueous hydrogen peroxide solution.

The high-pressure reverse osmosis membrane separation device used for purifying an aqueous hydrogen peroxide solution in the present invention is that conventionally used in seawater desalination plants. It has been used with a high membrane effective pressure (differential pressure between a primary side pressure and a secondary side pressure) of about 5.52 MPa in order to subject seawater having a high salt concentration to a reverse osmosis membrane treatment. The present applicant has proposed to use the high-pressure reverse osmosis membrane separation device for seawater desalination in the primary pure water system in ultrapure water production equipment and for the treatment of boron-containing water (see Patent Literatures 3 to 5). There has heretofore been no proposal to use a high-pressure reverse osmosis membrane separation device for purification of an aqueous hydrogen peroxide solution.

### CITATION LIST

### Patent Literature

PTL1: JPH 11-139811 A

PTL2: JP 2012-188318 A

PTL3: JP 2012-245439 A

PTL4: JP 2015-20131 A

PTL5: JP 2015-196113 A

The recent processes of manufacturing advanced wafers or advanced semiconductors have presented a conspicuous problem of irregular decreases in yield due to organic substances in a cleaning fluid.

This problem has been caused by a variation between manufacturing lots in a TOC concentration in an aqueous hydrogen peroxide solution in the cleaning fluid even though the TOC concentration is not more than its controlled concentration. Such a variation has been attributed to the fact that TOC and boron in an aqueous hydrogen peroxide solution cannot be sufficiently removed by purification with the conventional ion exchange treatment of an aqueous hydrogen peroxide solution or with a combination of this treatment with a reverse osmosis membrane separation treatment.

### SUMMARY OF INVENTION

An object of the present invention is to provide a purification method and a purification system for efficiently removing TOC and boron in an aqueous hydrogen peroxide solution to stably purify the aqueous hydrogen peroxide solution to high purity.

The present inventors have found that TOC and boron in an aqueous hydrogen peroxide solution can be efficiently removed to stably purify the aqueous hydrogen peroxide solution to high purity by subjecting the aqueous hydrogen peroxide solution to the treatment with a high-pressure reverse osmosis membrane separation device.

The high-pressure reverse osmosis membrane has been conventionally used for seawater desalination. However, the high-pressure reverse osmosis membrane has a denser skin layer on the membrane surface and is therefore lower in the amount of membrane permeate water per unit operating pressure but higher in the rejection rate of TOC and boron, as compared with a low-pressure or ultralow-pressure reverse osmosis membrane. Therefore, the high-pressure reverse osmosis membrane separation device can be used to highly purify an aqueous hydrogen peroxide solution.

The present invention is summarized as follows:

[1] A purification method for an aqueous hydrogen peroxide solution, comprising subjecting the aqueous hydrogen peroxide solution to a reverse osmosis membrane separation treatment, wherein the reverse osmosis membrane separation treatment is performed with a high-pressure reverse osmosis membrane separation device.

[2] The purification method for an aqueous hydrogen peroxide solution according to [1], wherein the high-pressure reverse osmosis membrane separation device has such characteristics as a permeation flux of pure water of 0.6 to 1.3 m³/m²/day and an NaCl rejection rate of 99.5% or more, at an effective pressure of 2.0 MPa and a temperature of 25° C.

[3] The purification method for an aqueous hydrogen peroxide solution according to [1] or [2], wherein permeate water from the reverse osmosis membrane separation treatment is further subjected to an ion exchange treatment comprising contacting the permeate water with ion exchange resins.

[4] The purification method for an aqueous hydrogen peroxide solution according to [3], wherein the ion exchange treatment comprises sequentially contacting the permeate water with a first gel-type H-form strong cation exchange resin, a gel-type salt-form strong anion exchange resin and a second gel-type H-form strong cation exchange resin.

[5] The purification method for an aqueous hydrogen peroxide solution according to [4], wherein:

the first gel-type H-form strong cation exchange resin is an H-form strong cation exchange resin having a degree of crosslinking of 9% or more, or an H-form strong cation exchange resin produced by the following steps (a) and (b); and

the second gel-type H-form strong cation exchange resin is an H-form strong cation exchange resin having a degree of crosslinking of 6% or less, an H-form strong cation exchange resin having a degree of crosslinking of 9% or more, or an H-form strong cation exchange resin produced by the following steps (a) and (b):

(a) a step of copolymerizing a monovinyl aromatic monomer with a crosslinkable aromatic monomer having a non-polymerizable impurity content of 3% by weight or less therein using a radical polymerization initiator at a concentration of 0.05% by weight or more and 5% by weight or less relative to the total weight of the monomers at a polymerization temperature of 70° C. or more and 250° C. or less to obtain a crosslinked copolymer, wherein at least benzoyl peroxide and t-butyl peroxybenzoate are used as the radical polymerization initiator; and

(b) a step of sulfonating the crosslinked copolymer.

[6] The purification method for an aqueous hydrogen peroxide solution according to [4] or [5], wherein the gel-type salt-form strong anion exchange resin is a salt-form strong anion exchange resin produced by the following steps (c), (d), (e), (f) and (g):

(c) a step of copolymerizing a monovinyl aromatic monomer with a crosslinkable aromatic monomer to obtain a crosslinked copolymer;

(d) a step of adjusting the polymerization temperature in the step (c) to 18° C. or more and 250° C. or less and setting a crosslinkable aromatic monomer content (purity) in the crosslinkable aromatic monomer at 57% by weight or more so that the content of an eluting compound represented by the chemical formula (I);

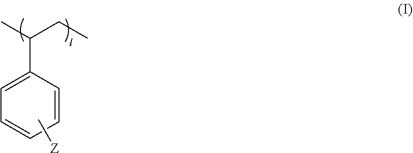

wherein Z represents a hydrogen atom or an alkyl group; and 1 represents a natural number;

is 400 μg or less relative to 1 g of the crosslinked copolymer of the monovinyl aromatic monomer and the crosslinkable aromatic monomer;

(e) a step of haloalkylating the crosslinked copolymer having the content of the eluting compound of 400 μg or less relative to 1 g of the crosslinked copolymer using a catalyst for Friedel-Crafts reaction in an amount of 0.001 to 0.7 parts by weight relative to 1 part by weight of the crosslinked copolymer;

(f) a step of washing the haloalkylated crosslinked copolymer with at least one solvent selected from the group consisting of benzene, toluene, xylene, acetone, diethyl ether, methylal, dichloromethane, chloroform, dichloroethane and trichloroethane to remove an eluting compound represented by the chemical formula (II):

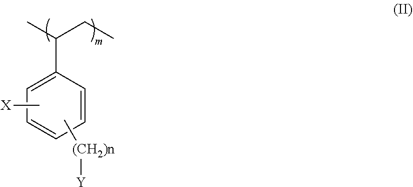

wherein X represents a hydrogen atom, a halogen atom or an alkyl group which may be substituted with a halogen atom; Y represents a halogen atom; and m and n each independently represent a natural number;

from the haloalkylated crosslinked polymer; and

(g) a step of reacting an amine compound with the haloalkylated crosslinked polymer from which the eluting compound has been removed.

[7] A purification system for an aqueous hydrogen peroxide solution for purifying the aqueous hydrogen peroxide solution by passing the aqueous hydrogen peroxide solution through a reverse osmosis membrane separation device, wherein the reverse osmosis membrane separation device is a high-pressure reverse osmosis membrane separation device.

[8] The purification system for an aqueous hydrogen peroxide solution according to [7], wherein the high-pressure reverse osmosis membrane separation device has such characteristics as a permeation flux of pure water of 0.6 to 1.3 m³/m²/day and an NaCl rejection rate of 99.5% or more, at an effective pressure of 2.0 MPa and a temperature of 25° C.

[9] The purification system for an aqueous hydrogen peroxide solution according to [7] or [8], comprising an ion exchange device through which permeate water from the reverse osmosis membrane separation device is passed.

[10] The purification system for an aqueous hydrogen peroxide solution according to [9], wherein the ion exchange device comprises a first gel-type H-form strong cation exchange resin column, a gel-type salt-form strong anion exchange resin column and a second gel-type H-form strong cation exchange resin column, and a means of sequentially passing the permeate water through the first gel-type H-form strong cation exchange resin column, the gel-type salt-form strong anion exchange resin column and the second gel-type H-form strong cation exchange resin column.

[11] The purification system for an aqueous hydrogen peroxide solution according to [10], wherein:

a gel-type H-form strong cation exchange resin packed in the first gel-type H-form strong cation exchange resin column is an H-form strong cation exchange resin having a degree of crosslinking of 9% or more, or an H-form strong cation exchange resin produced by the following steps (a) and (b); and

a gel-type H-form strong cation exchange resin packed in the second gel-type H-form strong cation exchange resin column is an H-form strong cation exchange resin having a degree of crosslinking of 6% or less, a H-form strong cation exchange resin having a degree of crosslinking of 9% or more, or an H-form strong cation exchange resin produced by the following steps (a) and (b):

(a) a step of copolymerizing a monovinyl aromatic monomer with a crosslinkable aromatic monomer having a non-polymerizable impurity content of 3% by weight or less therein using a radical polymerization initiator at a concentration of 0.05% by weight or more and 5% by weight or less relative to the total weight of the monomers at a polymerization temperature of 70° C. or more and 250° C. or less to obtain a crosslinked copolymer, wherein at least benzoyl peroxide and t-butyl peroxybenzoate are used as the radical polymerization initiator; and

(b) a step of sulfonating the crosslinked copolymer.

[12] The purification system for an aqueous hydrogen peroxide solution according to [10] or [11], wherein a gel-type salt-form strong anion exchange resin packed in the gel-type salt-form strong anion exchange resin column is a salt-form strong anion exchange resin produced by the following steps (c), (d), (e), (f) and (g):

(c) a step of copolymerizing a monovinyl aromatic monomer with a crosslinkable aromatic monomer to obtain a crosslinked copolymer;

(d) a step of adjusting the polymerization temperature in the step (c) to 18° C. or more and 250° C. or less and setting a crosslinkable aromatic monomer content (purity) in the crosslinkable aromatic monomer at 57% by weight or more so that the content of an eluting compound represented by the chemical formula (I);

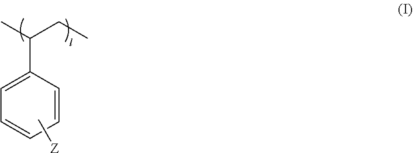

wherein Z represents a hydrogen atom or an alkyl group; and 1 represents a natural number;

is 400 μg or less relative to 1 g of the crosslinked copolymer of the monovinyl aromatic monomer and the crosslinkable aromatic monomer;

(e) a step of haloalkylating the crosslinked copolymer having the content of the eluting compound of 400 μg or less relative to 1 g of the crosslinked copolymer using a catalyst for Friedel-Crafts reaction in an amount of 0.001 to 0.7 parts by weight relative to 1 part by weight of the crosslinked copolymer;

(f) a step of washing the haloalkylated crosslinked copolymer with at least one solvent selected from the group consisting of benzene, toluene, xylene, acetone, diethyl ether, methylal, dichloromethane, chloroform, dichloroethane and trichloroethane to remove an eluting compound represented by the chemical formula (II):

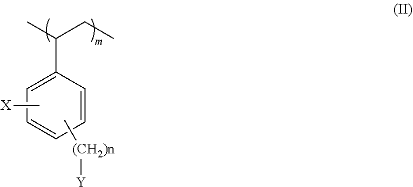

wherein X represents a hydrogen atom, a halogen atom or an alkyl group which may be substituted with a halogen atom; Y represents a halogen atom; and m and n each independently represent a natural number;

from the haloalkylated crosslinked polymer; and

(g) a step of reacting an amine compound with the haloalkylated crosslinked polymer from which the eluting compound has been removed.

### Advantageous Effects of Invention

According to the present invention, not only metals but also TOC and boron in an aqueous hydrogen peroxide solution can be highly removed with a high-pressure reverse osmosis membrane separation device, and a demanding high-purity aqueous hydrogen peroxide solution can be thus produced stably and reliably with no variation between lots.

According to the present invention, for example, when an aqueous hydrogen peroxide solution is purified by using a combination of a reverse osmosis membrane separation device with an ion exchange device, the solution is subjected to a treatment with a high-pressure reverse osmosis membrane separation device. This makes it possible to obtain a high-purity permeate water having not only TOC but also metal ions removed therefrom and to thereby reduce the load to the ion exchange device and reduce the processing cost of the entire devices.

### BRIEF DESCRIPTION OF DRAWINGS

FIG. 1 is a systematic diagram showing an example of an embodiment of a purification system for an aqueous hydrogen peroxide solution of the present invention.

FIG. 2a and FIG. 2b are systematic diagrams showing embodiments of ion exchange devices suitable for the present invention.

### DESCRIPTION OF EMBODIMENTS

Hereinafter, a purification method and a purification system for an aqueous hydrogen peroxide solution of the present invention will be described in detail with reference to the drawings. It should be understood that the following description is only illustrative of embodiments of the present invention which is not limited thereto, without departing from the scope of the invention.

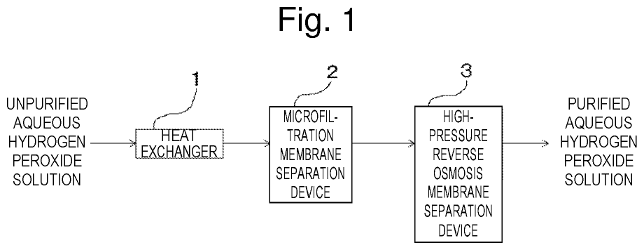

FIG. 1 is a systematic diagram showing an embodiment of a purification system for an aqueous hydrogen peroxide solution of the present invention.

The purification system for an aqueous hydrogen peroxide solution shown in FIG. 1 is intended to purify an unpurified aqueous hydrogen peroxide solution by sequentially passing it through a heat exchanger 1, a microfiltration membrane separation device 2 and a high-pressure reverse osmosis membrane separation device 3.

The heat exchanger 1 is intended to adjust the temperature of the unpurified aqueous hydrogen peroxide solution of 5 to 25° C. obtained by distillation under reduced pressure or the like so as not to increase the temperature as compared with that before starting the treatment. As a result, oxidative degradation of the reverse osmosis membrane caused by self-decomposition of hydrogen peroxide can be inhibited. The microfiltration membrane separation device 2 is used for removing impurities such as fine particles in the aqueous hydrogen peroxide solution.

The details of the high-pressure reverse osmosis membrane separation device 3 will be described below.

In the present invention, permeate water from the high-pressure reverse osmosis membrane separation device 3 is preferably further treated by subjecting it to two or more ion exchange treatments comprising contacting it with gel-type strong ion exchange resins. The ion exchange treatment preferably comprises sequentially contacting the permeate water with a first gel-type H-form strong cation exchange resin, a gel-type salt-form strong anion exchange resin and a second gel-type H-form strong cation exchange resin.

In such an ion exchange treatment, cationic metal ion impurities in the high-pressure reverse osmosis membrane permeate water can be removed by treatment with the first gel-type H-form strong cation exchange resin; anionic metallic impurities, a chloride ion and a sulfate ion can then be removed by treatment with the gel-type salt-form strong anion exchange resin; and trace amounts of metal ion impurities such as Na⁺, K⁺ or Al³⁺ contained as impurities in the upstream gel-type salt-form strong anion exchange resin are further highly removed by treatment with the second gel-type H-form strong cation exchange resin.

[Aqueous Hydrogen Peroxide Solution]

Examples of the aqueous hydrogen peroxide solution to be purified include an industrial aqueous hydrogen peroxide solution produced by a known production method such as the anthraquinone autoxidation method described above and a direct synthesis method by directly reacting hydrogen with oxygen. The hydrogen peroxide concentration in the aqueous hydrogen peroxide solution is not particularly limited and is any concentration of 70% by weight or less. In Japan, an industrial aqueous hydrogen peroxide solution is specified as having a hydrogen peroxide concentration of 35% by weight, 45% by weight or 60% by weight according to Japanese Industrial Standards, and the hydrogen peroxide concentration is usually any one of these concentrations.

As described above, the aqueous hydrogen peroxide solution may contain one or two or more stabilizers such as an inorganic chelating agent such as a phosphate, a pyrophosphate or a stannate; or an organic chelating agent such as ethylenediamine tetramethylene phosphonic acid, ethylenediamine tetraacetic acid or nitrilotriacetic acid. The stabilizers in the aqueous hydrogen peroxide solution are usually mostly removed by treatment with a high-pressure reverse osmosis membrane separation device.

[High-Pressure Reverse Osmosis Membrane Separation Device]

The high-pressure reverse osmosis membrane separation device used in the reverse osmosis membrane separation treatment of an aqueous hydrogen peroxide solution is a reverse osmosis membrane separation device conventionally used in seawater desalination. The high-pressure reverse osmosis membrane has a denser skin layer on the membrane surface than a low-pressure or ultralow-pressure reverse osmosis membrane conventionally used in the purification of an aqueous hydrogen peroxide solution. The high-pressure reverse osmosis membrane is therefore lower in the amount of permeate water per unit operating pressure but higher in the rejection rate of organic substances and boron, as compared with the low-pressure or ultralow-pressure reverse osmosis membrane.

As described above, the high-pressure reverse osmosis membrane separation device is low in the amount of membrane permeate water per unit operating pressure. The high-pressure reverse osmosis membrane separation device suitably used in the present invention has such characteristics as a permeation flux of pure water of 0.6 to 1.3 m³/m²/day and an NaCl rejection rate of 99.5% or more, at an effective pressure of 2.0 MPa and a temperature of 25° C. The effective pressure is an effective pressure acting on the membrane which is obtained by subtracting the osmotic pressure difference and the secondary side pressure from the average operating pressure. The NaCl rejection rate is a rejection rate of NaCl from an aqueous NaCl solution having a NaCl concentration of 32000 mg/L at 25° C. and an effective pressure of 2.0 PMa. The average operating pressure is the average of the pressure of a membrane feed water (operating pressure) on the primary side of the membrane and the pressure of a concentrated water (concentrated water outlet pressure) as expressed by the following equation:

Average operating pressure=(operating pressure+concentrated water outlet pressure)/2.

The high-pressure reverse osmosis membrane has a denser skin layer on the membrane surface than a low-pressure or ultralow-pressure reverse osmosis membrane. The high-pressure reverse osmosis membrane is thereby lower in the amount of membrane permeate water per unit operating pressure but extremely higher in the rejection rate of TOC and boron, as compared with the low-pressure or ultralow-pressure reverse osmosis membrane.

The high-pressure reverse osmosis membrane separation device used in the present invention is preferably an aromatic polyamide-based membrane. The geometry of the high-pressure reverse osmosis membrane is not particularly limited and it may have any geometry such as a 4-inch RD membrane, an 8-inch RO membrane or a 16-inch RO membrane of a spiral type or a hollow type or the like.

In the present invention, an aqueous hydrogen peroxide solution is preferably subjected to a reverse osmosis membrane separation treatment by passing it through such a high-pressure reverse osmosis membrane separation device at an operating pressure of 0.5 to 3.0 MPa and preferably 1.0 MPa or more and a water recovery rate of 50 to 90%. These values vary depending on the concentration of salts or the like in the aqueous hydrogen peroxide solution.

[Ion Exchange Device]

The permeate water obtained by treating the aqueous hydrogen peroxide solution with the high-pressure reverse osmosis membrane separation device is preferably further treated with an ion exchange device. The ion exchange device is preferably an ion exchange device comprising two or more columns packed with gel-type strong ion exchange resins. There is no particular limitation but the ion exchange device is preferably is an ion exchange device comprising gel-type H-form strong cation exchange resin columns both upstream and downstream of the gel-type salt-form strong anion exchange resin column.

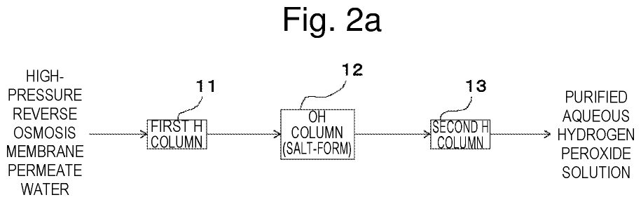

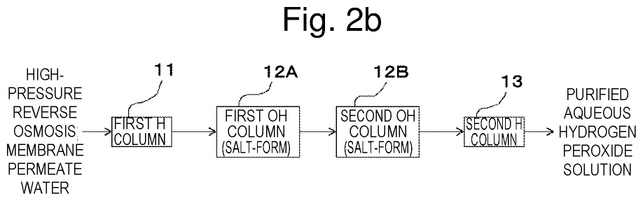

The ion exchange device suitable for the present invention will be described below with reference to FIG. 2a and FIG. 2b.

The ion exchange device shown in FIG. 2a is used for passing high-pressure reverse osmosis membrane permeate water, in the following order, through a first gel-type H-form strong cation exchange resin column (hereinafter sometimes referred to as “first H column”) 11, a gel-type salt-form strong anion exchange resin column (hereinafter sometimes referred to as “OH column”) 12 and a second gel-type H-form strong cation exchange resin column (hereinafter sometimes referred to as “second H column”) 13 to obtain a purified aqueous hydrogen peroxide solution.

The ion exchange device shown in FIG. 2b has such a configuration that two columns, i.e., a first gel-type salt-form strong anion exchange resin column (hereinafter sometimes referred to as “first OH column”) 12A and a second gel-type salt-form strong anion exchange resin column (hereinafter sometimes referred to as “second OH column”) 12B, which correspond to the gel-type salt-form strong anion exchange resin column in the ion exchange device shown in FIG. 2a, are arranged in series.

The number of each type of ion exchange resin column described above is not limited to one but may be two or more.

The ion exchange device may be any ion exchange device in which the high-pressure reverse osmosis membrane permeate water is contacted in the following order with the first gel-type H-form strong cation exchange resin, the gel-type salt-form strong anion exchange resin and the second gel-type H-form strong cation exchange resin for treatment. Each ion exchange resin may be packed in, but not limited to, a different column from each other, or two or more ion exchange resins may be laminated in the same column with a water-permeable partition plate(s) sandwiched therebetween.

When purifying the high-pressure reverse osmosis membrane permeate water by sequentially passing it through the first H column 11, the OH column 12 (or the first OH column 12 A and the second OH column 12B) and the second H column 13, it is preferable to use, as the first gel-type H-form strong cation exchange resin packed in the first H column 11, an H-form strong cation exchange resin having a degree of crosslinking of 9% or more (hereinafter sometimes referred to as “highly crosslinked resin”) or an H-form strong cation exchange resin produced by the following steps (a) and (b) (hereinafter sometimes referred to as “(a)-(b) resin”); to use, as the second gel-type H-form strong cation exchange resin packed in the second H column 13, an H-form strong cation exchange resin having a degree of crosslinking of 6% or less (hereinafter sometimes referred to as “low crosslinked resin”), a highly crosslinked resin having a degree of crosslinking of 9% or more, or an (a)-(b) resin; and to use, as the gel-type salt-form strong anion exchange resin packed in the OH column 12 (the first OH column 12A and/or the second OH column 12B), a salt-form strong anion exchange resin produced by the following steps (c), (d), (e), (f) and (g) (hereinafter sometimes referred to as “(c)-(g) resin”).

(a) a step of copolymerizing a monovinyl aromatic monomer with a crosslinkable aromatic monomer having a non-polymerizable impurity content of 3% by weight or less therein using a radical polymerization initiator at a concentration of 0.05% by weight or more and 5% by weight or less relative to the total weight of the monomers at a polymerization temperature of 70° C. or more and 250° C. or less to obtain a crosslinked copolymer, wherein at least benzoyl peroxide and t-butyl peroxybenzoate are used as the radical polymerization initiator; and

(b) a step of sulfonating the crosslinked copolymer.

(c) a step of copolymerizing a monovinyl aromatic monomer with a crosslinkable aromatic monomer to obtain a crosslinked copolymer;

(d) a step of adjusting the polymerization temperature in the step (c) to 18° C. or more and 250° C. or less and setting a crosslinkable aromatic monomer content (purity) in the crosslinkable aromatic monomer at 57% by weight or more so that the content of an eluting compound represented by the chemical formula (I):

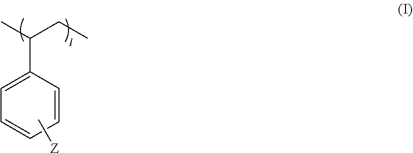

wherein Z represents a hydrogen atom or an alkyl group; and 1 represents a natural number;

is 400 μg or less relative to 1 g of the crosslinked copolymer of the monovinyl aromatic monomer and the crosslinkable aromatic monomer;

(e) a step of haloalkylating the crosslinked copolymer having the content of the eluting compound of 400 μg or less relative to 1 g of the crosslinked copolymer using a catalyst for Friedel-Crafts reaction in an amount of 0.001 to 0.7 parts by weight relative to 1 part by weight of the crosslinked copolymer;

(f) a step of washing the haloalkylated crosslinked copolymer with at least one solvent selected from the group consisting of benzene, toluene, xylene, acetone, diethyl ether, methylal, dichloromethane, chloroform, dichloroethane and trichloroethane to remove an eluting compound represented by the chemical formula (II):

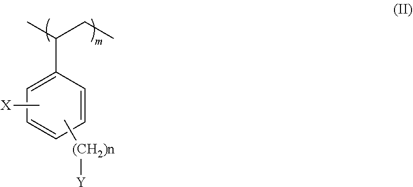

wherein X represents a hydrogen atom, a halogen atom or an alkyl group which may be substituted with a halogen atom; Y represents a halogen atom; and m and n each independently represent a natural number; from the haloalkylated crosslinked polymer; and

(g) a step of reacting an amine compound with the haloalkylated crosslinked polymer from which the eluting compound has been removed.

The gel-type resins are used as ion exchange resin for the following reasons:

The ion exchange resins include gel-type ion exchange resins and porous-type ion exchange resin. The gel-type ion exchange resins are preferred because they are smaller in the surface area and more oxidation-resistant to hydrogen peroxide in the purification of an aqueous hydrogen peroxide solution and they can therefore increase purification purity and purification stability more, as compared with the porous-type ion exchange resins.

The “degree of crosslinking” means the weight ratio of the weight of a crosslinkable aromatic monomer as a crosslinking agent to the total of the weight of a monovinyl aromatic monomer and the crosslinkable aromatic monomer used for manufacturing an ion exchange resin. This is similar to the definition as used in the art.

A greater amount of the crosslinkable aromatic monomer used provides a denser resin having more network structure as a result of its chain structure more crosslinked, whereas a less amount of the crosslinkable aromatic monomer used provides a resin having a coarser network structure.

The commercially available ion exchange resins have a degree of crosslinking of about 4 to 20%. The resins having a degree of crosslinking of about 8% which is a region of easily removing ions are use as standard crosslinking resins in the usual water treatment. For this reason, the ion exchange resin used in Patent Literature 2 has the degree of crosslinking of 6 to 10 and preferably 7 to 9.

<Highly Crosslinked Resin>

The gel-type H-form strong cation exchange resin having a degree of crosslinking of 9% or more, which is used as the first gel-type H-form strong cation exchange resin in the first H column 11 and/or the second gel-type H-form strong cation exchange resin in the second H column 13, is a resin having an excellent oxidation resistance to hydrogen peroxide and having a low elution property, and its use in, for example, the first H column 11 can thereby reduce the load from eluted materials to the downstream OH column 12 (the first OH column 12A and/or the second OH column 12B) and to stabilize the purification treatment.

Therefore, the first column 11 is preferably packed with the highly crosslinked resin.

When using the highly crosslinked resin in the second H column 13, a high oxidation resistance can also be obtained in the second H column 13.

The degree of crosslinking of the highly crosslinked resin is 9% or more and preferably more than 9%, and from the viewpoint of the balance between oxidation resistance and treatment efficiency, more preferably 10 to 20% and particularly preferably 11 to 16%. The resin having a degree of crosslinking of 12% or more is particularly excellent in oxidation resistance and elution resistance.

<Low Crosslinked Resin>

The gel-type H-form strong cation exchange resin, having a degree of crosslinking of 6% or less, used in the second H column 13 is higher in rejection efficiency and washing efficiency than standard crosslinked resins and can efficiently remove TOC (such as amines) eluted from the upstream OH column 12 (the first OH column 12A and/or the second OH column 12B), and is therefore suitable as a gel-type H-form strong cation exchange resin packed in the second H column 13.

The degree of crosslinking of the low crosslinked resin is 6% or less and preferably less than 6% such as 5% or less. The lower limit of the degree of crosslinking is usually about 4% since the lower limit of the degree of crosslinking of commercially available ion exchange resins is about 4%.

The low crosslinked resin preferably has ΔTOC of 20 μg/L or less as measured according to the ultrapure water passing test of (i) below.

(i) Ultrapure water passing test

1) Ultrapure water is passed through an empty measurement column alone at a space velocity (SV) of 50 hr⁻¹ with respect to the amount of a low crosslinked resin to be measured. After passing ultrapure water for 1 hour, the TOC concentration (TOC₀) in the outlet water of the measurement column alone is analyzed.
2) The low crosslinked resin to be measured is packed in the measurement column in the above 1), and then ultrapure water is passed through the measurement column packed with the low crosslinked resin at an SV of 50 hr⁻¹ with respect to the amount of the low crosslinked resin. After passing ultrapure water for 1 hour, the TOC concentration (TOC₁) in the outlet water of the measurement column is analyzed.
3) From the analysis results of 1) and 2) above, ΔTOC is calculated by the following equation:

ΔTOC=TOC₁−TOC₀

The water quality of the ultrapure water used in (i) ultrapure water passing test described above is as follows: resistivity: 18.0 MΩ·cm or more; TOC: 2 μg/L or less; silica: 0.1 μg/L or less; fine particles of ϕ50 nm or more; 5 particles/mL or less; metals: 1 ng/L or less; and anions: 1 ng/L or less.

If the low crosslinked resin has ΔTOC of 20 μg/L or less as measured according to the ultrapure water passing test of (i) described above, the elution amount of TOC from the resin is small. Use of the downstream second H column 13 packed with such a low crosslinked resin can stably provide a high-purity aqueous hydrogen peroxide solution.

<(A)-(b) Resin>

(a)-(b) resin is produced by the above steps (a) and (b), and the elution amount of TOC from the resin is small. Use of the first H column 11 and/or the second H column packed with the (a)-(b) resin can stably provide a high-purity aqueous hydrogen peroxide solution.

Examples of the monovinyl aromatic monomer used in the step (a) include one or two or more of styrene, an alkyl-substituted styrene such as methylstyrene or ethylstyrene and a halogen-substituted styrene such as bromostyrene. It is preferably styrene or a monomer mainly composed of styrene.

Examples of the crosslinkable aromatic monomer include one or two or more of divinylbenzene, trivinylbenzene, and divinyltoluene. It is preferably divinylbenzene.

The amount of the crosslinkable aromatic monomer to be used varies depending on whether the (a)-(b) resin is used for the first H column 11 or the second H column 13. When using it in the first H column 11, the amount of the crosslinkable aromatic monomer to be used is preferably 9% by weight or more, particularly 10 to 20% by weight and especially 11 to 16% by weight relative to the total weight of the monomers so as to obtain a highly crosslinked resin. When using it in the second H column 13, the amount of the crosslinkable aromatic monomer to be used is preferably 6% by weight or less and particularly 4 to 6% by weight relative to the total weight of the monomers so as to obtain the above-described highly crosslinked resin or a low crosslinked resin.

The degree of crosslinking of the (a)-(b) resin is not limited to 9% or more or 6% or less and can be broadly set in the range of 4 to 20%.

Examples of the radical polymerization initiator to be used include dibenzoyl peroxide, lauroyl peroxide, t-butyl hydroperoxide and azobisisobutyronitrile, but benzoyl peroxide and t-butyl peroxybenzoate are at least used.

The mode of polymerization is not particularly limited, and polymerization may be carried out in various modes such as solution polymerization, emulsion polymerization or suspension polymerization. The suspension polymerization process capable of producing a homogeneous bead-like copolymer is preferably adopted. The suspension polymerization process can be carrying by using such a solvent and a dispersion stabilizer as generally used in the production of this type of copolymer and selecting known reaction conditions.

The polymerization temperature in the copolymerization reaction is 70° C. or more and 250° C. or less, preferably 150° C. or less, and more preferably 140° C. or less. Too high a polymerization temperature causes depolymerization concurrently and rather reduces the degree of polymerization completion. Too low a polymerization temperature leads to an insufficient degree of polymerization completion.

The polymerization can be carried out under an atmosphere of air or an inert gas. Examples of the inert gas to be used include nitrogen, carbon dioxide and argon.

The sulfonation in the step (b) can be carried out according to any conventional method.

The thus obtained (a)-(b) resin usually has a low elution property with ΔTOC of 5 μg/L or less as measured according to the ultrapure water passing test of (i) described above.

<Gel-Type Salt-Form Strong Anion Exchange Resin>

There is no particular limitation to the type of salt form of the gel-type salt-form strong anion exchange resin to be packed in the OH column 12 (the first OH column 12A and/or the second OH column 12B) and the method for producing it in the salt form. Examples of the salt form include a carbonate salt form, a bicarbonate salt form, a halogenide (F, Cl or Br) form and a sulfate form. It is preferably a bicarbonate salt form or carbonate salt form.

The gel-type salt-form strong anion exchange is preferably an (c)-(g) resin described above, since the latter is small in the elution amount from the resin and can stably provide a high-purity aqueous hydrogen peroxide solution.

Examples of the monovinyl aromatic monomer used in the step (c) include one or two or more of styrene, an alkyl-substituted styrene such as methylstyrene or ethylstyrene and a halogen-substituted styrene such as bromostyrene. It is preferably styrene or a monomer mainly composed of styrene.

Examples of the crosslinkable aromatic monomer include one or two or more of divinylbenzene, trivinylbenzene and divinyltoluene. It is preferably divinylbenzene.

The amount of the crosslinkable aromatic monomer to be used may be in any ratio capable of providing the (c)-(g) resin having a suitable degree of crossing.

The copolymerization reaction of the monovinyl aromatic monomer with the crosslinkable aromatic monomer can be carried out with a radical polymerization initiator, based on any known technique.

Examples of the radical polymerization initiator to be used include one or two or more dibenzoyl peroxide, lauroyl peroxide, t-butyl hydroperoxide and azobisisobutyronitrile. The radical polymerization initiator is usually used in an amount of 0.05% by weight or more and 5% by weight or less relative to the total weight of the monomers.

The mode of polymerization is not particularly limited, and polymerization may be carried out in various modes such as solution polymerization, emulsion polymerization or suspension polymerization. Among them, the suspension polymerization process capable of producing a homogeneous bead-like copolymer is preferably adopted. The suspension polymerization process can be carrying by using such a solvent and a dispersion stabilizer as generally used in the production of this type of copolymer and selecting known reaction conditions.

The polymerization temperature in the copolymerization reaction is usually room temperature (about 18° C. to 25° C.) or more, preferably 40° C. or more, more preferably 70° C. or more, and usually 250° C. or less, preferably 150° C. or less and more preferably 140° C. or less. Too high a polymerization temperature causes depolymerization concurrently and rather reduces the degree of polymerization completion. Too low a polymerization temperature leads to an insufficient degree of polymerization completion.

The polymerization can be carried out under an atmosphere of air or an inert gas. Examples of the inert gas to be used include nitrogen, carbon dioxide and argon.

The alkyl group represented by Z in the eluting compound represented by the above formula (I) in the step (d) (hereinafter sometimes referred to as “eluting compound (I)”) is an alkyl group having 1 to 8 carbon atoms, preferably a methyl group, an ethyl group, a propyl group or a butyl group and more preferably a methyl group or an ethyl group.

The content of the eluting compound (I) in the crosslinked copolymer to be subjected to haloalkylation in the step (e), which is more than 400 μg relative to 1 g of the aqueous hydrogen peroxide solution, cannot provide an anion exchange resin reduced in an amounts of eluted materials and having residual impurities and generation of decomposition products inhibited therein. The content of the eluting compound (I) is preferably as low as possible, preferably 30 μg or less and more preferably 200 μg or less relative to 1 g of the aqueous hydrogen peroxide solution, and the lower limit thereof is usually about 50 μg.

The step (d) is carried out particularly simultaneously with the step (c) by adjusting the polymerization conditions in the step (c). For example, the polymerization temperature in the step (c) can be adjusted to 18° C. or more and 250° C. or less to increase the degree of polymerization completion, providing a crosslinked copolymer reduced in the eluting compound (I). The crosslinkable aromatic monomer such as divinylbenzene contains non-polymerizable impurities such as diethylbenzene, which cause the generation of the eluting compound (I). Therefore, selection and use of a crosslinkable aromatic monomer to be used for polymerization of a specific grade having a crosslinkable aromatic monomer content (purity) of 57% by weight or more can provide a crosslinked copolymer low in the content of the eluting compound (I).

The crosslinkable aromatic monomer content (purity) of the crosslinkable aromatic monomer is particularly preferably 60% by weight or more, and further preferably 80% by weight or more. The content of the non-polymerizable impurities in the crosslinkable aromatic monomer is usually 5% by weight or less per monomer weight, preferably 3% by weight or less per monomer weight, and more preferably 1% by weight or less per monomer weight. The crosslinkable aromatic monomer having too high impurity content is likely to cause chain transfer reaction with the impurities during polymerization, which may lead to an increase in the amount of the eluting oligomer (polystyrene) remaining in the polymer after completion of polymerization, and cannot thus provide any crosslinked copolymer low in the content of the eluting compound (I).

The eluting compound (I) can be also removed after polymerization by washing the resulting crosslinked copolymer, to obtain a crosslinked copolymer reduced in the content of the eluting compound.

The step (e) of haloalkylating the crosslinked copolymer is a step of haloalkylating the crosslinked copolymer obtained in the step (d) by reacting it in a swollen state with a haloalkylating agent in the presence of a catalyst for Friedel-Crafts reaction.

A swelling solvent such as dichloroethane can be used to swell the crosslinked copolymer. The crosslinked copolymer is preferably swollen with only a haloalkylating agent in order to allow halomethylation to sufficiently proceed.

Examples of the catalyst for Friedel-Crafts reaction include Lewis acid catalysts such as zinc chloride, iron (III) chloride, tin (IV) chloride and aluminum chloride. These catalysts may be used alone or in combination of two or more.

It is preferable to use a haloalkylating agent having a high compatibility with the copolymer, in order to allow the haloalkylating agent to act not only as a reaction reagent but also as a swelling solvent for the copolymer. Examples of such a haloalkylating agent include a halogen compound such as chloromethyl methyl ether, methylene chloride, bis(chloromethyl)ether, polyvinyl chloride and bis(chloromethyl)benzene. These may be used alone or in combination of two or more. A more preferred haloalkylating agent is chloromethyl methyl ether. The haloalkylation in the present invention is preferably chloromethylation.

It is preferable that the introduction rate of the haloalkyl group in the step (e) is 80% or less, preferably 75% or less and more preferably 70% or less relative to the theoretical halogen content when 100 mol % of the monovinyl aromatic monomer is assumed to be haloalkylated. Increasing such an induction rate of the haloalkyl group (the percentage of the introduced halogen atom to the theoretical halogen content when 100 mol % of the monovinyl aromatic monomer is assumed to be haloalkylated) causes the main chain of the crosslinked copolymer to be cleaved at the time of introduction and cause the excessively introduced haloalkyl group to be released after introduction, resulting in impurities. Limitation of the introduction rate of the haloalkyl group makes it possible to inhibit production of impurities to provide an anion exchange resin reduced in the amounts of eluted materials.

Limitation of the introduction amount of the haloalkyl group also reduces the side reaction in the haloalkylation step and is thereby less likely to generate the eluting oligomer. The by-product generated which is difficult to be removed by washing at the later steps is also less than those of conventional formulations. As a result, it is possible to provide an anion exchange resin remarkably reduced in the amounts of eluted materials.

A specific method for introducing a haloalkyl group is as follows:

The amount of a haloalkylating agent to be used is selected from a wide range depending on the degree of crosslinking of a crosslinked copolymer and other conditions, but it is preferably at least enough an amount to swell the crosslinked copolymer, usually 1 part by weight or more, preferably 2 parts by weight or more and usually 50 parts by weight or less and preferably 20 parts by weight or less relative to 1 part by weight of the crosslinked copolymer.

The amount of the catalyst for the Friedel-Crafts reaction to be used is usually 0.001 to 7 parts by weight, preferably 0.1 to 0.7 parts by weight and more preferably 0.1 to 0.7 parts by weight relative to 1 part by weight of the crosslinked copolymer.

Examples of the means for adjusting the introduction rate of the haloalkyl group into the crosslinked copolymer to 80% or less include such a means as lowering the reaction temperature, using a low-activity catalyst or decreasing the amount of the catalyst to be added. Examples of the main factor affecting the reaction of the crosslinked copolymer with the haloalkylating agent include a reaction temperature, the activity (type) of catalyst for Friedel-Crafts reaction and the amount thereof added, the amount of the haloalkylating agent added, and the like. Therefore, adjustment of the conditions makes it possible to control the introduction rate of the haloalkylating agent.

The reaction temperature also varies depending on the type of catalyst for Friedel-Crafts reaction to be used, but it is usually 0 to 55° C. The preferred reaction temperature range varies depending on the haloalkylating agent to be used and the catalyst for Friedel-Crafts reaction to be used. For example, the preferred reaction temperature range is usually 30° C. or more, preferably 35° C. or more and usually 50° C. or less and preferably is 45° C. or less, when using chloromethyl methyl ether as a haloalkylating agent and zinc chloride as a catalyst for Friedel-Crafts reaction. At this time, excessive introduction of the haloalkyl group can be inhibited by appropriately selecting the reaction time and the like.

In the introduction reaction of the haloalkyl group, the post-crosslinking reaction also proceeds simultaneously. The introduction of the haloalkyl group means also ensuring the strength of the final product by the post-crosslinking reaction, and it is therefore better to secure some time for the haloalkyl group introduction reaction. The reaction time of haloalkylation is preferably 30 minutes or more, more preferably 3 hours or more and further preferably 5 hours or more. The reaction time of haloalkylation is preferably 24 hours or less, more preferably 12 hours or less and further preferably 9 hours or less.

The step (f) is a step of purifying the haloalkylated crosslinked copolymer by washing it with the particular solvent described above to remove the eluting compound represented by the above formula (II) (hereinafter sometimes referred to as “eluting compound (II)”) so that the content of the eluting compound (II) is preferably 400 μg or less, more preferably 100 μg or less, particularly preferably 50 μg or less and especially preferably 30 μg or less relative to 1 g of the haloalkylated crosslinked copolymer. The high content of the eluting compound (II) cannot provide an anion exchange resin reduced in the amounts of the eluted materials and having residual impurities and generation of decomposition products inhibited therein. The content of eluting compound (II) is preferably as low as possible, but the lower limit thereof is usually about 30 μg.

In the formula (II), the alkyl group which may be substituted with a halogen atom represented by X is usually an alkyl group or a haloalkyl group having 1 to 10 carbon atoms, preferably a methyl group, an ethyl group, a propyl group, a butyl group, a halomethyl group, a haloethyl group, a halopropyl group or a halobutyl group, and more preferably a methyl group, an ethyl group, a halomethyl group or a haloethyl group.

n is usually 1 or more and usually 8 or less, preferably 4 or less and more preferably 2 or less.

The washing process with the above-described solvent can be carried out by a column process in which the solvent is passed through a column packed with a haloalkylated crosslinked copolymer, or by a batch washing process.

The washing temperature is usually room temperature (20° C.) or more, preferably 30° C. or more, more preferably 50° C. or more and particularly preferably 90° C. or more, and usually 150° C. or less, preferably 130° C. or less and more preferably 120° C. or less. Too high a washing temperature causes decomposition of the polymer and elimination of the haloalkyl group concurrently. Too low a washing temperature reduces the washing efficiency.

The length of contact time with the solvent is usually 5 minutes or longer, preferably not shorter than a length of time it takes to swell 80% or more of the crosslinked copolymer, and usually 4 hours or shorter. Too short a length of contact time reduces the washing efficiency, whereas too long a length of contact time reduces the productivity.

The step (g) is a step of reacting with an amine compound the haloalkylated crosslinked copolymer having the eluting compound (II) removed therefrom to introduce an amino group thereinto so as to produce an anion exchange resin. Introduction of the amino group can be easily carried out by any known technique.

Examples of the introduction technique include a process in which a haloalkylated crosslinked copolymer is suspended in a solvent and allowed to react with trimethylamine or dimethylethanolamine.

Examples of the solvent to be used for the introduction reaction include water, toluene, dioxane, dimethylformamide and dichloroethane, which are used alone or in combination.

Subsequently, the salt form is converted into the each desired form by any known process to obtain a salt-form strong anion exchange resin to be packed in the OH column 2 (the first OH column 2A and/or the second OH column 2B).

The salt-form strong anion exchange resin obtained by thus converting the (c)-(g) resin into its salt form is usually a resin having a low elution property with ΔTOC of 20 μg/L or less as measured according to the ultrapure water passing test of (i) described above.

<Configuration Example of Resin Column>

Specific examples of the ion exchange device include those having the following configurations of resin columns:

### Configuration Example 1

an ion exchange device in which the ion exchange process is sequentially carried out with: a highly crosslinked resin column→a gel-type salt-form strong anion exchange resin column→a low crosslinked resin column.

### Configuration Example 2

an ion exchange device in which the ion exchange process is sequentially carried out with: a highly crosslinked resin column→a gel-type salt-form strong anion exchange resin column→a highly crosslinked resin column.

As described above, the upstream first 1H column 11 packed with the highly crosslinked resin excellent in oxidation resistance reduces the elution amount from the first H column 11 thereby reducing the load to the downstream OH column 12 (the first OH column 12A and/or the second OH column 12B).

In the configuration example 1 using the low crosslinked resin used in the downstream second H column 13, TOC (such as amines) eluted from the gel-type salt-form strong anion exchange resin in the upstream OH column 12 (the first OH column 12A and/or the second OH column 12B) can be removed and further efficiently washed and regenerate in the downstream second H column 13.

In the configuration example 2 using the highly crosslinked resin used in the downstream second H column 13, the elution amount can be reduced with sufficiently high oxidation resistance also in the second H column 13.

In both of the configuration examples 1 and 2, impurities such as metal ions in high-pressure reverse osmosis membrane permeate water can be highly removed by ion exchange with the gel-type salt-form strong anion exchange resin and gel-type H-form strong cation exchange resin to inhibit TOC from eluting from the resins and to thereby stably obtain a high-purity aqueous hydrogen peroxide solution.

The amount of the resins packed in resin columns and water passing conditions are not particularly limited. The packing amounts of gel-type salt-form strong anion exchange resin(s) and gel-type H-form strong cation exchange resin(s) (ratio by volume) and the space velocity (SV) are preferably designed in a balanced manner depending on the impurity concentration in the aqueous hydrogen peroxide solution before purification.

### EXAMPLES

The present invention will be more specifically described below with reference to Example and Comparative Example.

In the following Example and Comparative Example, 35% by weight of industrial aqueous hydrogen peroxide solution having TOC of about 15 mg/L (pH: neutral) was subjected to a purification treatment.

### Example 1

The industrial aqueous hydrogen peroxide solution was treated at a water recovery rate of 70% by passing it through a high-pressure reverse osmosis membrane separation device with the following specifications at a water temperature of 25° C. and an operating pressure of 2.0 MPa. The boron concentration was adjusted to 100 μg/L.

<High-Pressure Reverse Osmosis Membrane Separation Device>

High-pressure reverse osmosis membrane: an aromatic polyamide-based reverse osmosis membrane “SWC4+” manufactured by Nitto Denko Corporation

Pure water permeation flux at an effective pressure of 2.0 MPa and a temperature of 25° C.: 0.78 m³/m²/day

NaCl rejection rate at an effective pressure of 2.0 MPa and a temperature of 25° C. (at an NaCl concentration of 32000 mg/L): 99.8%

The TOC concentration in feed water (inlet water) fed to the high-pressure reverse osmosis membrane separation device and the TOC concentration in the resulting permeate water was measured with an off-line TOC meter (“TOC-VCPH” manufactured by Shimadzu Corporation). Results are shown in Table 1.

### Comparative Example 1

The industrial aqueous hydrogen peroxide solution was treated under the same conditions as in Example 1 except that a low-pressure reverse osmosis membrane (“ES-20” manufactured by Nitto Denko Corporation) was used instead of the high-pressure reverse osmosis membrane and the solution was passed therethrough at an operating pressure of 0.5 MPa, and the TOC concentrations in water fed to the reverse osmosis membrane and the resulting permeate water were measured in the same manner as in Example 1. Results are shown in Table 1.

TABLE 1

TOC[mg/L]

| | Feed water | Permeate water |
|---|---|---|
| Example 1 | 15.0 | 1.0 |
| Comparative Example 1 | 14.9 | 7.5 |

Table 1 shows as follows:

The TOC can be efficiently removed by treatment with the high-pressure reverse osmosis membrane separation device having a dense skin layer on the membrane surface and thereby having a high TOC rejection rate.

The boron concentration in permeate water from the high-pressure reverse osmosis membrane separation device in Example 1 could be reduced to about 8 μg/L, and the load to the downstream ion exchange devices could thereby be reduced. By contrast, the boron concentration in permeate water from the low-pressure reverse osmosis membrane separation device in Comparative Example 1 was about 70 μg/L.

These therefore show that application of the high-pressure reverse osmosis membrane separation device having a high impurity rejection rate can inhibit the ion exchange capacities from decreasing in the downstream ion exchange devices and can thereby decrease the frequency of regeneration defects and decrease the frequency of reduced treatment time (reduce the regeneration frequency).

According to the present invention, it is thus possible to reduce efficiently and greatly the concentration of TOC in an aqueous hydrogen peroxide solution and reduce the production cost thereof, by clarifying the conditions for a reverse osmosis membrane to be applied in the purification of the aqueous hydrogen peroxide solution with the reverse osmosis membrane separation device.

The present invention has been described in detail with reference to specific embodiments, but it will be apparent to those skilled in the art that various modifications are possible without departing from the spirit and scope of the present invention.

The present application is based on Japanese Patent Application No. 2016-206085 filed on Oct. 20, 2016, the entirety of which is incorporated herein by reference.

### Reference Sings List

1 heat exchanger
2 microfiltration membrane separation device
3 high-pressure reverse osmosis membrane separation device
11 first gel-type H-form strong cation exchange resin column (first H column)
12 gel-type salt-form strong anion exchange resin column (OH column)
12A first gel-type salt-form strong anion exchange resin column (first OH column)
12B second gel-type salt-form strong anion exchange resin column (second OH column)
13 second gel-type H-form strong cation exchange resin column (second H column)

1. A purification method for an aqueous hydrogen peroxide solution, comprising subjecting the aqueous hydrogen peroxide solution to a reverse osmosis membrane separation treatment, wherein the reverse osmosis membrane separation treatment is performed with a high-pressure reverse osmosis membrane separation device.

2. The purification method for an aqueous hydrogen peroxide solution according to claim 1, wherein the high-pressure reverse osmosis membrane separation device has such characteristics as a permeation flux of pure water of 0.6 to 1.3 m³/m²/day and an NaCl rejection rate of 99.5% or more, at an effective pressure of 2.0 MPa and a temperature of 25° C.

3. The purification method for an aqueous hydrogen peroxide solution according to claim 1, wherein permeate water from the reverse osmosis membrane separation treatment is further subjected to an ion exchange treatment comprising contacting the permeate water with ion exchange resins.

4. The purification method for an aqueous hydrogen peroxide solution according to claim 3, wherein the ion exchange treatment comprises sequentially contacting the permeate water with a first gel-type H-form strong cation exchange resin, a gel-type salt-form strong anion exchange resin and a second gel-type H-form strong cation exchange resin.

5. The purification method for an aqueous hydrogen peroxide solution according to claim 4, wherein:
the first gel-type H-form strong cation exchange resin is an H-form strong cation exchange resin having a degree of crosslinking of 9% or more, or an H-form strong cation exchange resin produced by the following steps (a) and (b); and
the second gel-type H-form strong cation exchange resin is an H-form strong cation exchange resin having a degree of crosslinking of 6% or less, an H-form strong cation exchange resin having a degree of crosslinking of 9% or more, or an H-form strong cation exchange resin produced by the following steps (a) and (b):
(a) a step of copolymerizing a monovinyl aromatic monomer with a crosslinkable aromatic monomer having a non-polymerizable impurity content of 3% by weight or less therein using a radical polymerization initiator at a concentration of 0.05% by weight or more and 5% by weight or less relative to the total weight of the monomers at a polymerization temperature of 70° C. or more and 250° C. or less to obtain a crosslinked copolymer, wherein at least benzoyl peroxide and t-butyl peroxybenzoate are used as the radical polymerization initiator; and
(b) a step of sulfonating the crosslinked copolymer.

6. The purification method for an aqueous hydrogen peroxide solution according to claim 4, wherein the gel-type salt-form strong anion exchange resin is a salt-form strong anion exchange resin produced by the following steps (c), (d), (e), (f) and (g):
(c) a step of copolymerizing a monovinyl aromatic monomer with a crosslinkable aromatic monomer to obtain a crosslinked copolymer;
(d) a step of adjusting the polymerization temperature in the step (c) to 18° C. or more and 250° C. or less and setting a crosslinkable aromatic monomer content (purity) in the crosslinkable aromatic monomer at 57% by weight or more so that the content of an eluting compound represented by the chemical formula (I): 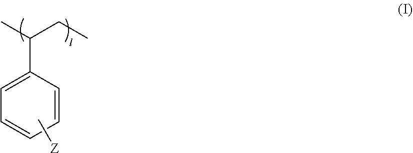
wherein Z represents a hydrogen atom or an alkyl group; and 1 represents a natural number;
is 400 μg or less relative to 1 g of the crosslinked copolymer of the monovinyl aromatic monomer and the crosslinkable aromatic monomer;
(e) a step of haloalkylating the crosslinked copolymer having the content of the eluting compound of 400 μg or less relative to 1 g of the crosslinked copolymer using a catalyst for Friedel-Crafts reaction in an amount of 0.001 to 0.7 parts by weight relative to 1 part by weight of the crosslinked copolymer;
(f) a step of washing the haloalkylated crosslinked copolymer with at least one solvent selected from the group consisting of benzene, toluene, xylene, acetone, diethyl ether, methylal, dichloromethane, chloroform, dichloroethane and trichloroethane to remove an eluting compound represented by the chemical formula (II): 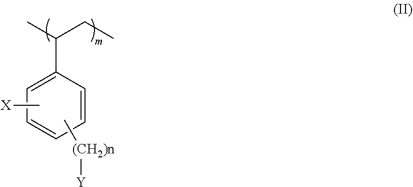
wherein X represents a hydrogen atom, a halogen atom or an alkyl group which may be substituted with a halogen atom; Y represents a halogen atom; and m and n each independently represent a natural number;
from the haloalkylated crosslinked polymer; and
(g) a step of reacting an amine compound with the haloalkylated crosslinked polymer from which the eluting compound has been removed.

7. A purification system for an aqueous hydrogen peroxide solution for purifying the aqueous hydrogen peroxide solution by passing the aqueous hydrogen peroxide solution through a reverse osmosis membrane separation device, wherein the reverse osmosis membrane separation device is a high-pressure reverse osmosis membrane separation device.

8. The purification system for an aqueous hydrogen peroxide solution according to claim 7, wherein the high-pressure reverse osmosis membrane separation device has such characteristics as a permeation flux of pure water of 0.6 to 1.3 m³/m²/day and an NaCl rejection rate of 99.5% or more, at an effective pressure of 2.0 MPa and a temperature of 25° C.

9. The purification system for an aqueous hydrogen peroxide solution according to claim 7, comprising an ion exchange device through which permeate water from the reverse osmosis membrane separation device is passed.

10. The purification system for an aqueous hydrogen peroxide solution according to claim 9, wherein the ion exchange device comprises a first gel-type H-form strong cation exchange resin column, a gel-type salt-form strong anion exchange resin column and a second gel-type H-form strong cation exchange resin column, and a means of sequentially passing the permeate water through the first gel-type H-form strong cation exchange resin column, the gel-type salt-form strong anion exchange resin column and the second gel-type H-form strong cation exchange resin column.

11. The purification system for an aqueous hydrogen peroxide solution according to claim 10, wherein:
a gel-type H-form strong cation exchange resin packed in the first gel-type H-form strong cation exchange resin column is an H-form strong cation exchange resin having a degree of crosslinking of 9% or more, or an H-form strong cation exchange resin produced by the following steps (a) and (b); and
a gel-type H-form strong cation exchange resin packed in the second gel-type H-form strong cation exchange resin column is an H-form strong cation exchange resin having a degree of crosslinking of 6% or less, a H-form strong cation exchange resin having a degree of crosslinking of 9% or more, or an H-form strong cation exchange resin produced by the following steps (a) and (b):
(a) a step of copolymerizing a monovinyl aromatic monomer with a crosslinkable aromatic monomer having a non-polymerizable impurity content of 3% by weight or less therein using a radical polymerization initiator at a concentration of 0.05% or more and 5% by weight or less by weight relative to the total weight of the monomers at a polymerization temperature of 70° C. or more and 250° C. or less to obtain a crosslinked copolymer, wherein at least benzoyl peroxide and t-butyl peroxybenzoate are used as the radical polymerization initiator; and
(b) a step of sulfonating the crosslinked copolymer.

12. The purification system for an aqueous hydrogen peroxide solution according to claim 10, wherein a gel-type salt-form strong anion exchange resin packed in the gel-type salt-form strong anion exchange resin column is a salt-form strong anion exchange resin produced by the following steps (c), (d), (e), (f) and (g):
(c) a step of copolymerizing a monovinyl aromatic monomer with a crosslinkable aromatic monomer to obtain a crosslinked copolymer;
(d) a step of adjusting the polymerization temperature in the step (c) to 18° C. or more and 250° C. or less and setting a crosslinkable aromatic monomer content (purity) in the crosslinkable aromatic monomer at 57% by weight or more so that the content of an eluting compound represented by the chemical formula (I): 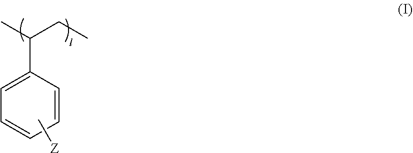
wherein Z represents a hydrogen atom or an alkyl group; and 1 represents a natural number;
is 400 μg or less relative to 1 g of the crosslinked copolymer of the monovinyl aromatic monomer and the crosslinkable aromatic monomer;
(e) a step of haloalkylating the crosslinked copolymer having the content of the eluting compound of 400 μg or less relative to 1 g of the crosslinked copolymer using a catalyst for Friedel-Crafts reaction in an amount of 0.001 to 0.7 parts by weight relative to 1 part by weight of the crosslinked copolymer;
(f) a step of washing the haloalkylated crosslinked copolymer with at least one solvent selected from the group consisting of benzene, toluene, xylene, acetone, diethyl ether, methylal, dichloromethane, chloroform, dichloroethane and trichloroethane to remove an eluting compound represented by the chemical formula (II): 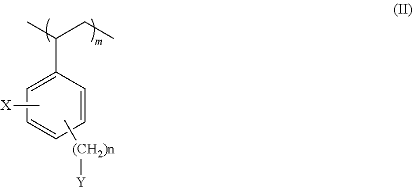
wherein X represents a hydrogen atom, a halogen atom or an alkyl group which may be substituted with a halogen atom; Y represents a halogen atom; and m and n each independently represent a natural number;
from the haloalkylated crosslinked polymer; and
(g) a step of reacting an amine compound with the haloalkylated crosslinked polymer from which the eluting compound has been removed.
